(19) United States
(12) Patent Application Publication
(10) Pub. No.: US 2008/0055256 A1
(43) Pub. Date: Mar. 6, 2008

(54) TOUCH SCREEN CONTROLLER WITH EMBEDDED OVERLAY

(75) Inventors: Wah Yiu Kwong, Beaverton, OR (US); Hong W. Wong, Portland, OR (US)

Correspondence Address: GROSSMAN, TUCKER, PERREAULT & PFLEGER, PLLC;C/O PORTFOLIO IP, P. O. BOX 52050, MINNEAPOLIS, MN, 55402, US

(73) Assignee: INTEL CORPORATION, Santa Clara, CA (US)

(21) Appl. No.: 11/469,166

(22) Filed: Aug. 31, 2006

(51) Int. Cl. G06F 3/041

(52) U.S. Cl. 345/173

(57) ABSTRACT

A method according to one embodiment may include receiving, by a touch screen controller, an overlay request signal. The method may also include reading, by the touch screen controller, overlay information stored in a memory device. The method may also include sending, by the touch screen controller, the overlay information to a display independently of a host operating system executed by a host processor. Many alternatives, variations and modifications are possible without departing from this embodiment.

### FIELD

The present disclosure relates to a touch screen controller with embedded overlay.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 illustrates one exemplary system embodiment in accordance with the present disclosure;

FIG. 2 illustrates another exemplary system embodiment according to the present disclosure; and

FIG. 3 is a flowchart illustrating exemplary operations according to one embodiment.

Although the following Detailed Description will proceed with reference being made to illustrative embodiments, many alternatives, modifications, and variations thereof will be apparent to those skilled in the art.

### DETAILED DESCRIPTION

Generally, this disclosure describes a touch-screen controller that may be configured to display overlay information on a display independently of an operating system and/or application software running on a system CPU. The overlay information may be stored in a memory device and may be transmitted to the display over an embedded communication bus. The touch screen controller described herein may be configured to quickly display overlay information and may offer enhanced power saving over conventional software approaches.

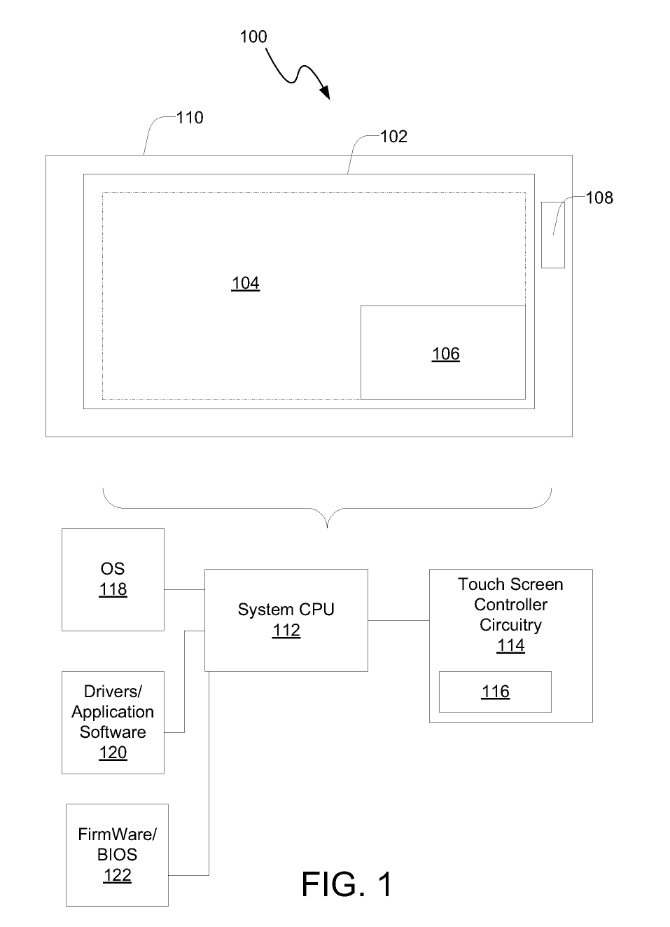

FIG. 1 illustrates one exemplary system embodiment 100. The handheld device of FIG. 1 may be representative of a personal digital assistant (PDA), cellphone, laptop computer, tablet PC or ultra mobile personal computer (UMPC). Of course, this list is non-exhaustive and only represents examples of handheld devices consistent with this disclosure. The handheld device 100 may generally include a display screen 102, a touch screen 104, a housing 110 at least partially enclosing the display screen 102 and at least one activator 108. The device 100 may also include a system CPU 112 (“host processor”) which may be configured to execute an operating system (OS) 118, System BIOS/Firmware 122 and one or more drivers and/or applications (e.g., software applications) 120. In addition, the device 100 may include a touch screen controller 114 to control the operation of touch screen 104 and to generate overlay information 106, as will be described in greater detail below.

Display screen 102 may be selected from one or more readily-available display technologies, for example, liquid crystal displays (LCDs), cathode ray tubes (CRTs), plasma displays, surface-conduction electron-emitter displays (SEDs) and organic light-emitting diode (OLED). Of course, alternative display technologies and/or after-developed display technologies may be used. Display screen 102 may be entirely or partially covered by touch screen 104.

Touch screen 104 may be configured to generate input/output (I/O) signals in response tactile pressure at certain locations within the touch screen 104 (e.g. touching a particular portion of touch screen 104 using a stylus, finger, etc.). Touch screen 104 may comprise a clear (e.g., glass or plastic) panel having a touch responsive surface. Touch screen 104 may be placed over display screen 102 and configured so that the responsive portion of touch screen 104 substantially covers the viewable area of display screen 102. Touch screen 104 may be selected from among a plurality of readily available touch screen technologies, for example, pressure-sensitive (resistive), acoustically-sensitive (surface wave), photo-sensitive (infrared), and electrically-sensitive (capacitive) touch screens.

In some embodiments, activator 108 may be coupled to, and/or form part of, housing 110 of the device 100. Alternatively, activator 108 may be located as user-selectable menu item within touch screen 104. Activator 108 may be configured to generate an overlay request signal to touch screen controller circuitry to generate an overlay 106 on display 102. Activator 108 could be configured in a variety of different arrangements including, but not limited to, a mechanical/electronic switch, button, lever, motion sensor and/or voice-activation. In alternate embodiments, multiple activators, each corresponding to a different overlay may be used.

Moreover, activator 108 may be configured to provide a menu overlay to the display screen 102. The menu overlay may provide the user with the option of selecting an additional overlay from a list. For example, a calculator overlay could be present with a keyboard overlay such as a QWERTY keyboard. The location and size of the display of the overlay 106 may be altered for the convenience of the user.

Touch screen controller 114 may include memory 116 configured to store overlay information. Touch screen controller 114 may also be configured to control the touch screen 104 to display overlay information stored in memory 116 as an overlay 106. As depicted in FIG. 1, overlay 106 may be positioned within the touch screen 104 to permit the overlay 106 to be used as a touch virtual device. Overlay information may include a keyboard information, menu information, calculator information and/or setup information, and may also include the visual size and shape (as displayed on display 102) of such information. For example, overlay information (stored in memory 116) may comprise a virtual QWERTY keyboard, which may be displayed as an overlay 106 on the touch screen 104. Of course, various alternative keyboards and keyboard arrangements may be used. Alternatively or additionally, overlay information may include a virtual calculator. Further, overlay information may be provided in a variety of different languages and may include various character layouts.

Memory 116 may comprise one or more of the following types of memories: semiconductor firmware memory, programmable memory, non-volatile memory, read only memory, electrically programmable memory, random access memory, flash memory (which may include, for example, NAND or NOR type memory structures), magnetic disk memory, and/or optical disk memory. In this embodiment, memory 116 may comprise a flash memory. Either additionally or alternatively, memory 116 may comprise other and/or later-developed types of computer-readable memory.

To generate an overlay 106, touch screen controller 114 may receive a request from activator 108. In response to activator 108, touch screen controller may read the contents of memory 116 and control the display 102 to display the overlay 106. Alternatively, a request for an overlay may be generated via touch screen 104, for example, via a menu or icon for an overlay. In at least one embodiment, touch screen controller 114 may be configured to receive a request to display overlay 106 and display overlay 106 independently of the OS 118 and/or drivers or applications 120 executed by the host processor 112. For example, a user may depress a button (e.g. activator 108), which may trigger a request input to touch screen controller 114 to display overlay 106. In response thereto, touch screen controller 114 may read overlay information stored in memory 116 and control display 102 to display the overlay information as an overlay 106 on touch screen 102.

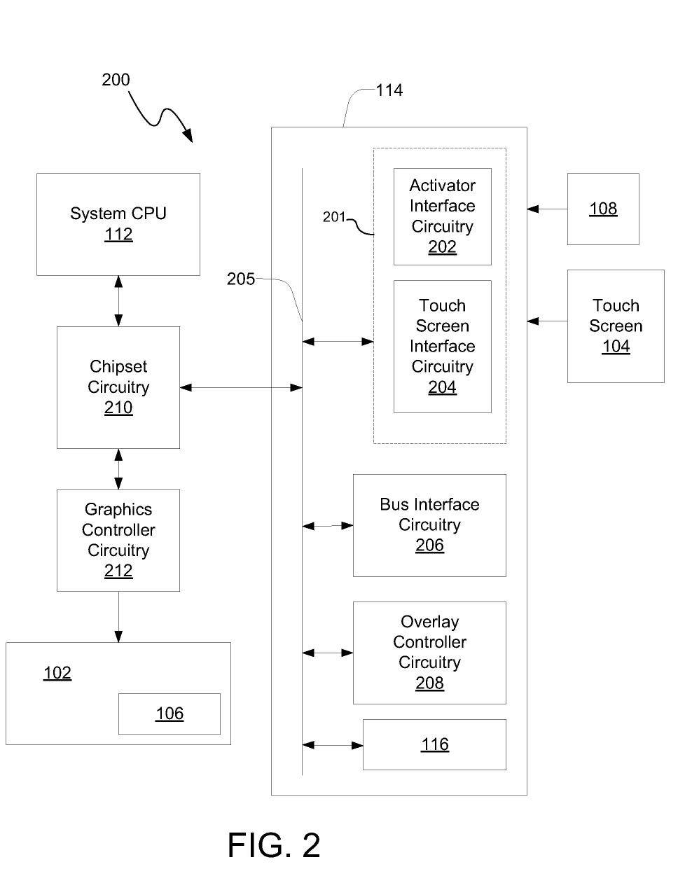

FIG. 2 illustrates another exemplary embodiment 200, and in particular, illustrates in more detail the touch screen controller 114 of FIG. 1. Touch screen controller 114 may include interface circuitry 201, bus interface circuitry 206, overlay controller circuitry 208 and memory 116. The interface circuitry 201 may include activator interface circuitry 202, touch screen interface circuitry 204. The components of controller 114 may be coupled to an embedded communications bus 205 to exchange commands and data between components. “Circuitry”, as used in any embodiment herein, may comprise, for example, singly or in any combination, hardwired circuitry, programmable circuitry, state machine circuitry, and/or firmware that stores instructions executed by programmable circuitry. It should be understood at the outset that any of the operative components of the touch screen controller 114 may also be implemented in software, firmware, hardwired circuitry and/or any combination thereof.

Embedded communication bus 205 may comply or be compatible with, for example, the Intel® Low Pin Count Interface Specification, Revision 1.1, Published August 2002 (hereinafter referred to as an “LPC bus”) and/or The I²C-Bus Specification, Version 2.1, Published January 2000, available from Philips Semicoinductor (hereinafter referred to as an “I2C bus”) and/or the System Management Bus (SMBUS) Specification, Version 2.0, published Aug. 3, 2000, available at the SBS Implementors Forum (hereinafter referred to as an “SMBus”) and/or other and/or after-developed bus technology and/or bus standards. Accordingly, bus interface circuitry 206 may be configured to control bus 205 to permit devices attached thereto to communicate using a selected bus communication protocol. Bus interface circuitry 206 may control the exchange commands and data between devices coupled to bus 205, and as such, communication of such devices coupled to bus 205 may involve one or more transactions with bus interface circuitry 206 to facilitate such communication via bus 205.

The embodiment of FIG. 2 may also include system chipset circuitry 210 and graphics controller circuitry 212. System chipset 210 may comprise a host bridge/hub system that may couple host processor 112 and graphics controller circuitry 212 to each other and to a bus 205. System chipset 210 may also include an input/output (I/O) bridge/hub system (not shown) that may couple the host bridge/bus system to bus 205. System chipset 210 may comprise integrated circuit chips, such as those selected from integrated circuit chipsets commercially available from the assignee of the subject application. In alternative embodiments, chipset 212 and graphics controller circuitry 212 may be combined into a single chipset, for example, memory and I/O controller hub chipsets (North Bridge/South Bridge), (e.g., Intel® I/O Controller Hub 6 (ICH6) family and/or lntel®965 Express chipset), although other integrated circuit chips may also, or alternatively be used, without departing from this embodiment.

Graphics controller circuitry 212 may be configured to drive display 102 coupled thereto to display graphical video information. Graphics controller circuitry may comprise one or more integrated circuit chips, such as those selected from integrated circuits commercially available from the assignee of the subject application.

Interface circuitry 201 may be configured to receive, at least in part, an overlay request signal and one or more inputs from a touch screen. An overlay request signal may be generated by, for example, activator 108 and/or touch screen 104. Activator interface circuitry 202 may be configured to receive one or more signals from activator 108 to display overlay information (stored in memory 116) as an overlay 106 on display 102. In response to a signal generated by activator 108, activator interface circuitry 202 may generate one or more commands to overlay controller circuitry 208 to cause the display of overlay 106 on display 102. To that end, overlay controller circuitry 208 may be configured to read overlay information stored in memory 116, in response to a command from activator interface circuitry 202, and pass the overlay information to the display 102 via bus 205 and chipset 210. Further, touch screen controller 114 may be configured to control the display of the overlay 106 independently of the system CPU 112 and/or independently of an OS or application software executed by the host processor.

Touch screen interface circuitry 204 may be configured to respond to one or more signals from the touch screen 104. As stated, touch screen 104 may be used to request an overlay 106, in addition to or alternatively to, the activator 108. In response thereto, touch screen interface circuitry 204 may pass commands and data to chipset circuitry 210, via bus 205, to achieve an operation, for example, a user-requested input from the touch screen 104. To that end, touch screen interface circuitry 204 may be configured to interpret a user input on the touch screen 104. For example, if touch screen 104 is a resistive touch screen system, electrical current may run through two layers (e.g., a conductive layer and a metallic layer) until a user touches the screen, at which point the two layers make contact at that particular position and a change in the electrical field may be produced. Touch screen interface circuitry 204 may be configured to detect the change in electrical field and calculate the coordinates of the point of contact. Once the coordinates are known, touch screen interface circuitry 204 may pass that information to chipset 210 and system CPU 112 to respond to the input on the touch screen.

As stated, overlay controller circuitry 208 may be configured to read overlay information stored in memory 116 and pass the overlay information to chipset circuitry 210, via bus 205, to display the overlay information as an overlay 106 on display 102. In addition, overlay controller circuitry 208 may be configured to generate overlay information and store the overlay information in memory 116 for future access via activator 108. Once the overlay 106 is displayed on display 102 touch screen interface circuitry 204 may receive touch screen inputs related to the overlay 106 (for example, a user selecting letters and/or punctuation and/or numerals from an overlay configured as a QWERTY keyboard). In response thereto, touch screen interface circuitry 204 may pass commands and data to system CPU 112, via bus 205 and chipset circuitry 210 to respond to inputs from the touch screen 104.

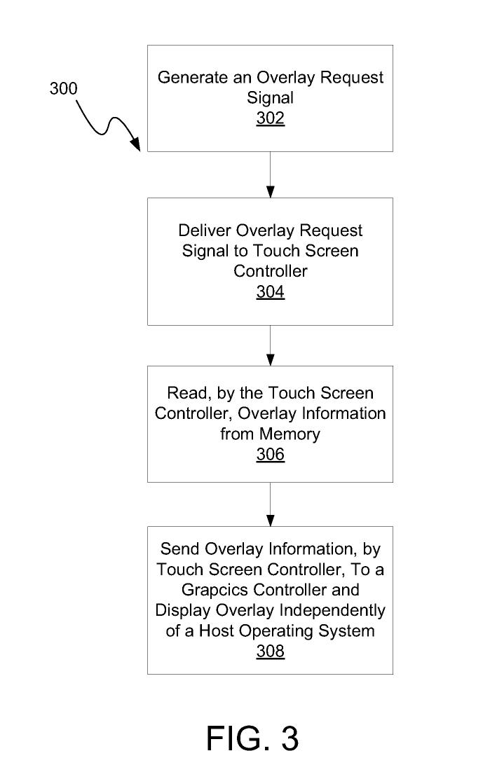

FIG. 3 depicts a flowchart 300 of operations in accordance with one embodiment of the present disclosure. Operations may include generating an overlay request signal at 302. An overlay request signal may be generated by, for example, a dedicated mechanical/electronic activator switch and/or a touch screen input. Operations may further include delivering the overlay request signal to a touch screen controller at 304. In response to an overlay request signal, operations may additionally include reading, by the touch screen controller, overlay information from memory at 306. Operations may also include sending the overlay information, by the touch screen controller, to a graphics controller to display and overlay independently of a host operating system at 308.

In alternative embodiments, the operations depicted in FIG. 3 may be executed at a pre-boot stage. For example, in an environment that does not include a physical keyboard (e.g., tablet PC), the operations of FIG. 3 may be executed at a pre-boot stage (e.g., before an OS is booted) to permit, for example, a keyboard overlay to be used to update BIOS setup information.

Embodiments of the methods described above may be implemented in a computer program that may be stored on a storage medium having instructions to program a system to perform the methods. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions. Other embodiments may be implemented as software modules executed by a programmable control device.

It should be noted that system CPU 112 may comprise any variety of processors. For example, system CPU 112 may comprise one or more ARM architectures such as the Intel® XScale™ Core micro-architecture described in “Intel® XScale™ Core Developers Manual,” published December 2000 by the Assignee of the subject application. Of course, system CPU 112 may comprise alternative types of processors without departing from this embodiment. The OS 118, System BIOS/System Firmware 122 executed by system CPU 112, may include, for example, Micosoft Windows, Linux, lntel®Tiano BIOS. In addition, system CPU 112, chipset circuitry 210, graphics controller circuitry 212 and touch screen controller 114 may collectively or individually comprise one or more integrated circuits. “Integrated circuit” (IC), as used in any embodiment herein, means a semiconductor device and/or a microelectronic device, such as, for example, but not limited to, a semiconductor integrated circuit chip. Of course, the operative components of FIGS. 1 and 2 may be implemented using one or more application specific integrated circuits (ASIC) and/or other circuitry configured to operate as described herein. Additionally, the operative components of the touch screen controller 114 depicted in the embodiment of FIG. 2 (e.g., interface circuitry 201, bus interface circuitry 206, overlay controller circuitry 208 and memory 116) may be embodied as a single integrated circuit and/or multiple integrated circuits. Thus, for example, although memory 116 is depicted graphically as within the controller 114, it is equally contemplated herein that memory 116 may be external to controller 116. The same applies for any of the components of controller 114.

Accordingly, at least one embodiment described herein may provide an integrated circuit (IC) comprising interface circuitry and overlay controller circuitry configured to communicate with each other and with a host processor via an embedded communication bus. The interface circuitry may be configured to receive an overlay request signal. In response to the overlay request signal, the overlay controller circuitry may be configured to read overlay information stored in a memory device coupled to the embedded communication bus and to send the overlay information to a display, via said embedded communication bus, independently of a host operating system executed by the host processor.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed is:

1. An apparatus, comprising:
an integrated circuit (IC) comprising interface circuitry and overlay controller circuitry configured to communicate with each other and with a host processor via an embedded communication bus, said interface circuitry is configured to receive an overlay request signal, and, in response to said overlay request signal, said overlay controller circuitry is configured to read overlay information stored in memory coupled to said embedded communication bus and to send the overlay information to a display, via said embedded communication bus, independently of a host operating system to be executed by said host processor.

2. The apparatus of claim 1, wherein:
said interface circuitry comprises activator interface circuitry configured to receive said overlay request signal from an activator and generate one or more commands to said overlay controller circuitry to read and send said overlay information.

3. The apparatus of claim 1, wherein:
said interface circuitry comprises touch screen interface circuitry configured to receive one or more inputs from a touch screen and pass said inputs to said host processor via said embedded communication bus.

4. The apparatus of claim 1, wherein:
the embedded communication bus is selected from at least one of a low pin count bus (LPC), inter-integrated circuit bus (I2C) or a system management bus (SMbus).

5. The apparatus of claim 1, wherein:
the overlay information is selected from at least one of keyboard information, menu information, calculator information or setup information.

6. A method, comprising:
receiving, by a touch screen controller, an overlay request signal;
reading, by the touch screen controller, overlay information stored in memory; and
sending, by the touch screen controller, the overlay information to a display independently of an host operating system to be executed by a host processor.

7. The method of claim 6, further comprising:
providing an embedded communication bus within said touch screen controller to permit communication between said touch screen controller and a system chipset.

8. The method of claim 6, further comprising:
receiving, by the touch screen controller, one or more inputs from a touch screen; and
passing said inputs to said host processor.

9. The method of claim 9, further comprising:
selecting the overlay information from at least one of keyboard information, menu information, calculator information and setup information.

10. A system, comprising:
a handheld electronic device comprising a display screen, a touch screen, a host processor and a touch screen controller; said touch screen controller comprising interface circuitry and overlay controller circuitry configured to communicate with each other and with the host processor via an embedded communication bus, said interface circuitry is configured to receive an overlay request signal, and, in response to said overlay request signal, said overlay controller circuitry is configured to read overlay information stored in a memory device coupled to said embedded communication bus and to send the overlay information to a display, via said embedded communication bus, independently of a host operating system to be executed by the host processor.

11. The system of claim 10, wherein:
the handheld electronic device is selected from at least one of a cell phone, personal digital assistant, laptop computer, tablet personal computer or ultra-mobile personal computer.

12. The system of claim 10, further comprising:
a stylus configured for use with the touch screen.

13. The system of claim 10, wherein:
said interface circuitry comprises activator interface circuitry configured to receive said overlay request signal from an activator and generate one or more commands to said overlay controller circuitry to read and send said overlay information.

14. The system of claim 10, wherein:
said interface circuitry comprises touch screen interface circuitry configured to receive one or more inputs from the touch screen and pass said inputs to said host processor via said embedded communication bus.

15. The system of claim 10, wherein:
the overlay information is selected from at least one of keyboard information, menu information, calculator information or setup information.

16. An article, comprising:
a storage medium storing instructions that when executed by a machine result in the following operations:
receiving, by a touch screen controller, an overlay request signal;
reading, by the touch screen controller, overlay information stored in a memory device; and
sending, by the touch screen controller, the overlay information to a display independently of an host operating system executed by a host processor.

17. The article of claim 16, wherein said storage medium stores additional instructions that when executed by a machine result in the following additional operations:
providing an embedded communication bus within said touch screen controller to permit communication between said touch screen controller and a system chipset.

18. The article of claim 16, wherein said storage medium stores additional instructions that when executed by a machine result in the following additional operations:
receiving, by the touch screen controller, one or more inputs from a touch screen; and
passing said inputs to said host processor.
